(19) United States
(12) Patent Application Publication
(10) Pub. No.: US 2023/0128891 A1
(43) Pub. Date: Apr. 27, 2023

(54) METHOD, ELECTRONIC DEVICE AND SYSTEM FOR TRADING SIGNAL GENERATION OF FINANCIAL INSTRUMENTS USING GRAPH CONVOLVED DYNAMIC MODE DECOMPOSITION

(71) Applicant: Ming Ham YIP, Hong Kong (HK)

(72) Inventor: Ming Ham YIP, Hong Kong (HK)

(21) Appl. No.: 17/973,454

(22) Filed: Oct. 25, 2022

Related U.S. Application Data
(60) Provisional application No. 63/271,810, filed on Oct. 26, 2021.

(51) Int. Cl. G06Q 40/04

(52) U.S. Cl. CPC G06Q 40/04

(57) ABSTRACT

A computer-implemented method of generating trading signals for one or more financial instruments by an electronic device. The method includes: receiving, by a processor of the electronic device, time series data of one or more assets from a data source; pre-processing, by the processor, the time series data; extracting, by the processor, features from the pre-processed time series data to obtain a plurality of time series of feature vectors; calculating, by the processor, an affinity matrix representing pairwise similarity between each pair of the assets; calculating, by the processor, a graph convolved dynamic mode decomposition of data matrix assembled from extracted features; determining, by the processor, a prediction of the feature vectors for the assets; and extracting, by the processor, trading signals from the predicted feature vectors to the financial instruments.

### CROSS-REFERENCES WITH RELATED DOCUMENTS

This application claims priority to U.S. Patent Application No. 63/271,810 filed Oct. 26, 2021; the disclosure of which is incorporated herein by reference in its entirety.

### FIELD OF THE INVENTION

The present invention relates to techniques of generating trading signals for various asset classes. More particularly, the present invention relates to methods and systems for generating trading signals for various asset classes using Graph Convolved Dynamic Mode Decomposition (GCDMD).

### BACKGROUND OF THE INVENTION

In the era of Big Data, methods for automated trading of financial instruments are of great demand. Together with the advances in machine learning and hardware technologies, prediction of asset (including, but not limited to, equities, bonds, currencies, exchange traded funds, futures, options and their derivative products) prices can be done on an unprecedented scale, mining correlations and coupled dynamics between hundreds or even thousands of assets very effectively. In particular, the automatic generation of trading signals (buy or sell signals of assets) is of key importance to investment and asset management. The generated signals may be executed automatically through a trading system or disseminated to investors electronically who will then place trade orders in a means of his/her own preference. What is needed are methods that can digest multi-asset price data to generate trading signals in a timely and accurate manner. The methods should be capable of modeling dynamics of diverse asset classes.

### SUMMARY OF THE INVENTION

In accordance to one aspect of the present invention, a computer-implemented method of generating trading signals for one or more financial instruments by an electronic device is provided. The method includes: receiving, by a processor of the electronic device, time series data of one or more assets from a data source; preprocessing, by the processor, the time series data; extracting, by the processor, features from the preprocessed time series data to obtain a plurality of time series of feature vectors; calculating, by the processor, an affinity matrix representing pairwise similarity between each pair of the assets; calculating, by the processor, a graph convolved dynamic mode decomposition of data matrix assembled from extracted features; determining, by the processor, a prediction of the feature vectors for the assets; and extracting, by the processor, trading signals from the predicted feature vectors to the financial instruments.

In accordance with another aspect of the present invention, an electronic device for generating trading signals for one or more financial instruments is provided, and the electronic device includes one or more processors configured to execute machine instructions to implement the method described above.

### BRIEF DESCRIPTION OF THE DRAWINGS

Embodiments of the invention are described in more details hereinafter with reference to the drawings, in which:

FIG. 1 depicts a block diagram illustrating a system for trading signal generation in accordance with one embodiment of the present invention;

FIG. 2 illustrates a flowchart for trading signal generation, according to an embodiment of the invention; and

FIG. 3 is a flowchart of graph convolved dynamic mode decomposition.

### DETAILED DESCRIPTION

In the following description, methods and apparatuses for generating trading signals for various asset classes using Graph Convolved Dynamic Mode Decomposition (GCDMD) and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The technique of graph convolved dynamic mode decomposition (GCDMD) is disclosed herein for the purpose of generating trading signals (buy or sell) for a universe of financial instruments of various asset classes, including, but not limited to, equities, bonds, currencies, exchange traded funds, futures, options and their derivative products. The method inherits the capability of the traditional dynamic mode decomposition method (DMD) to estimate the dynamics of multiple time series data. Yet, unlike DMD, it does not require the specification of a low-rank matrix structure whose components are global in nature and may not be suitable for modeling diverse financial assets. In GCDMD, the structural dependence of various assets is captured by a weighted graph which is fed into a next step that integrates a graph convolution layer and DMD. The structure is therefore automatically determined and is more localized, which can represent groups of inter-related assets better. The number of model parameters is also greatly reduced, which prevents overfitting of data. The trading signal generation is achieved by a direct method at the computational cost of just one computation of a correlation matrix, a couple of singular value decompositions, and a linear least squares fitting. In contrast, recent Graph Convolution Networks (GCN) require iterations until some convergence criteria are met. The method therefore combines the best of DMD (dynamic modeling) and GCN (machine learning), yielding a novel method that is well-suited to modeling financial assets and is fast.

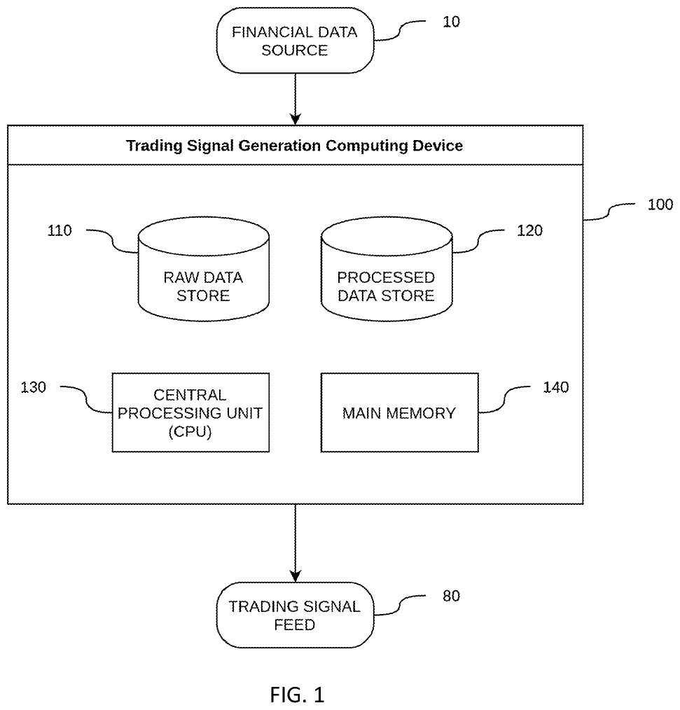

Referring to FIG. 1 for the following description. In accordance with various embodiments of the present invention, a system 1 includes a data source 10 (or called as financial data source) and an electronic device 100 (or called as trading signal generation computing device). The electronic device 100 includes a central processing unit (CPU) 130 and a main memory 140. As known to one of ordinary skills in the art, the CPU 130 is a processor that executes computer-executable instructions and manipulates data, and main memory 140 is a computer-readable medium (or a memory circuit) directly accessible by the CPU 130 via a memory bus, and usually includes volatile memory such as random-access memory (RAM). As also known to one of ordinary skill in the art, a computing device can use other processors such as Graphical Processing Unit (GPU), Tensor Processing Unit (TPU), smartphone processors, compute cards, compute sticks, and field-programmable gate array (FPGA), and/or the like, in addition to or in replacement of the CPU 130 to execute computer-executable instructions and manipulate data.

In some embodiments, the electronic device 100 also includes a raw data store 110 and a processed data store 120. The raw data store 110 is configured to be used by the trading signal generation computing device 100 to store asset price data received from the data source 10 before processing. The raw data store 110 may be configured to continue to retain the price data after processing, in order to enable the recalculation of the processed information or assemble time series (or for any other reason). The processed data store 120 is configured to store the final results and/or any intermediate results of the processing discussed herein. In some embodiments, one or both of the data stores may include storage on a non-volatile computer-readable medium coupled to the trading signal generation computing device 100, such as a hard drive, a flash drive, and/or the like. In some embodiments, one or both of the data stores may include storage that is accessible by the trading signal generation computing device 100 over a network, such as a cloud storage system, a network drive, a database accessible over the network, and/or the like. In some embodiments, the trading signal generation computing device 100 may operate on live asset price data and produce output trading signal feeds in a streaming manner, and so the raw data store 110 and/or the processed data store 120 may not be present or used.

In an embodiment, the electronic device 100 includes a data communication circuit (not shown), which is configured to establish a network connection between the electronic device 100 and one or more other electronic device. The network connection may connect to internet. The electronic device 100 can receive financial data from other electronic device (or database), and send generated trading signals to other electronic device via the established network connection by executing a corresponding Application Programming Interface (API).

In some embodiments, block 10 is a data source which may be a proprietary database, local files, or external database accessed through an API. In block 10, time series data of a given set of assets (including, but not limited to, equities, bonds, currencies, exchange traded funds, futures, options and their derivative products) are extracted from a data source and received by a computing device. Each asset may have multiple time series, e.g., an equity may have a “close price” time series, an “open price” time series, a “high price” time series, a “low price” time series, and a “volume” time series, sampled at a predetermined time interval.

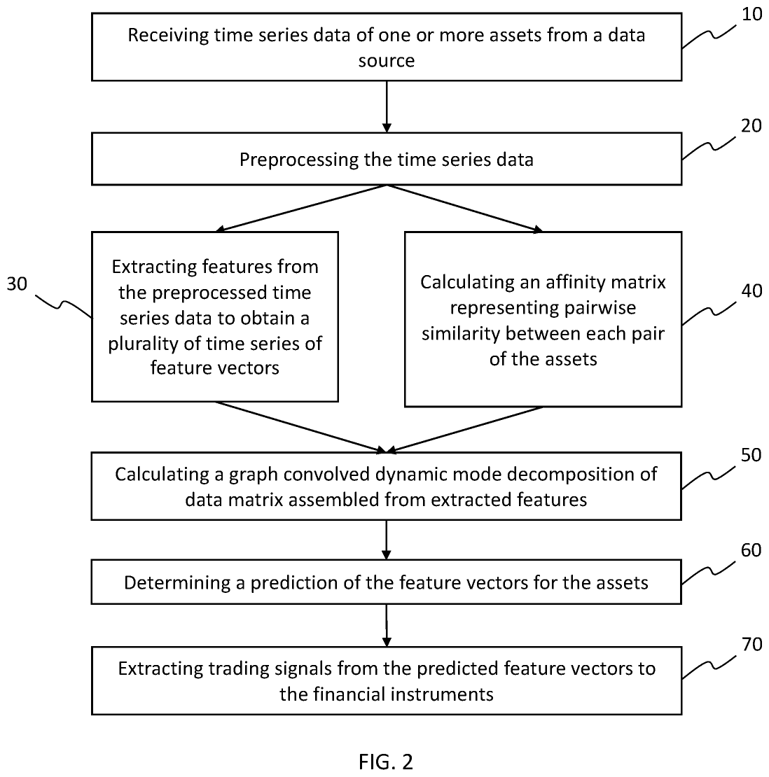

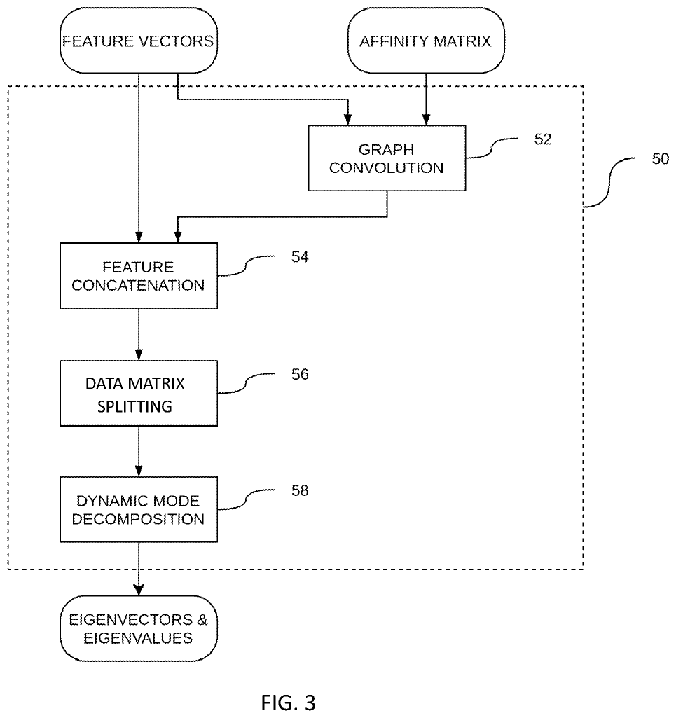

In some embodiments, block 80 represents the output trading signals for the assets concerned. Based on the trading signal feed, trading orders can be placed through a broker. Depending on the investor's preference, the selected assets may go through a portfolio optimization process to determine the optimal allocation of capital to each asset, but this is not in the scope of the disclosure. Book keeping of the trading signals may also have to be done to keep track of the holdings of the assets and to determine if the signals should be executed or ignored. The process described in FIG. 2 and FIG. 3 produces trading signals at one time instance. In applications, this process can be repeated according to a predefined schedule (e.g., every minute, hour, day, etc.) using the most updated price data to produce a continuous trading signal feed.

Asset price prediction (or up/down trend prediction) has been extensively studied for decades. Methods can be broadly classified as fundamental analysis and technical analysis. Due to recent advances in machine learning and computing, much research has been focused on technical analysis which adopts a data-driven approach to mine repetitive patterns and dynamics of price data.

In machine learning, neural networks enjoyed a resurgence since the invention of the AlexNet for object recognition in 2010. Neural networks are now the dominant method in many real-world applications of machine learning. Architecture of neural networks has evolved a lot in the past decades. The more well-known ones include Convolution Neural Network (CNN), Recurrent Neural Network (RNN), Generative Adversarial Network (GAN), and the more recent Transformer. RNN is a class of neural networks for processing sequences; examples of RNN include Long Short-Term Memory (LSTM), Gated Recurrent Unit (GRU) and plain RNN. There also exist a lot of different layer and architecture designs. Of particular mention is the Graph Neural Network (GNN). It is shown that in applications such as molecule classification and research literature classification, graph models can improve prediction accuracy to a large extent. Here, a graph provides an explicit way to describe relationships between entities, which can be used to make predictions based upon the most relevant variables or entities. Graph Convolutional Network (GCN) is one of the most successful kinds of GNN. A graph convolution layer simply aggregates features within neighborhoods defined by a graph. And the present invention makes use of the graph convolution technology to model asset prices.

Dynamic mode decomposition (DMD) is a data-driven equation-free method aimed to reconstruct the possibly nonlinear dynamics of a system. Originally designed by Peter Schmid to analyze fluid flows in 2008, the method decomposes time series of fluid flow fields into components of different characteristics, including decaying, growing, and oscillating. Dominant components can be easily extracted and predictions of flow fields can be made. The components also help scientists to understand the dynamics of the fluid in different conditions. DMD is deep rooted in the Koopman Operator theory. The latter says that a nonlinear dynamical system can be expressed as a superposition of some linear systems whose solutions are called Koopman eigenfunctions. The DMD provides an elegant way to reconstruct the dynamics of those linear systems from data, which then leads to the dynamics of the nonlinear system, at least approximately. DMD has now been successfully applied in many domains, including finance. Compared to neural networks, computation of DMD is much faster. The training step of DMD merely requires a few linear algebra operations such as singular value decomposition, eigenvalue decomposition, and linear least squares fitting. All these operations are pretty standard and are available in math libraries of many programming languages across platforms and hardware. This makes DMD attractive in applications such as intra-day trading, which requires a quick adaptation to changing trends. An application of DMD in foreground-background separation in video sequences is presented in U.S. Pat. No. 9,674,406B2.

Many neural network methods have been developed to predict equity prices. They use different neural network architectures and take different external factors (e.g., investor mood, economic factors, news articles) as inputs aside from historical prices. These methods, however, focus on the prediction of individual equity prices without exploiting correlations between equities. Since the introduction of GNN, several works have been devoted to the use of graph models to make predictions that exploit relationships between equities (or companies). In a conventional method (Y. Chen, Z. Wei, and X. Huang, Incorporating corporation relationship via graph convolutional neural networks for stock price prediction, in Proceedings of the 27th ACM International Conference on Information and Knowledge Management, 2018, pp. 1655-1658), a corporate relationship network is constructed where a node in the graph represents a company and an edge weight depicts the number of common top 10 stakeholders. In their joint prediction model, the historical prices are first transformed into numerical feature vectors through a LSTM neural network. The network and the associated feature vectors are then fed into a GCN to make predictions of equity prices. They showed that the use of the corporate relationship graph has improved the prediction accuracy. In a further conventional method (S. Peng, Stock forecasting using neural networks with graphs, M.Sc. Thesis, University of York, U.K., 2021), the author built a model similar to the one in the foregoing conventional method, but with a modification that three graphs are constructed to make three predictions (more precisely three feature vectors) of each equity and the price features are computed using Transformer instead of LSTM. The predictions are then fed into a simple feedforward neural network to make final predictions. The three graphs are constructed based on industry sector, price correlations, and Dynamic Time Warping of price series, respectively. The author showed that the use of three graphs improves the prediction accuracy compared to one graph alone. However, these studies are back-test studies which were done offline. In real trading, the training of the neural networks is very time-consuming.

A different paradigm for asset price prediction is based on dynamic modeling with dynamic mode decomposition. Evolution of asset prices is considered to be governed by an unknown, possibly nonlinear system of ordinary differential equations. The idea is to use previous observed prices to recover the dynamics of the system, so as to make predictions. Several works towards this direction in equity price prediction use the conventional DMD formulation to compute predictions. They differ by the choice of the model parameters to suit different markets and by the trading decision methodologies after predicted prices are obtained. The disclosure herein differs from price prediction methods based on the conventional DMD method, and the provided method used to generate the predicted prices is a novel price prediction model, called GCDMD, which is presented below.

In the conventional DMD method, it is shown that the DMD method works well for equities in a few selected industrial sectors within the Standard and Poor's 500 (S&P 500) Index. Generally speaking, the sectors consist of equities that are of higher correlations than a pool of diverse equities. Prediction accuracy deteriorates in the presence of diverse assets. The provided method is to develop an improved DMD based method that works for a larger pool of mixed assets by incorporating an asset relationship graph through a graph convolution layer to localize the DMD computation automatically and dynamically. The reason why the built method is based on DMD is that it is light-weighted in computational requirements which makes it suitable and adaptive even for intra-day trading (predictions of longer horizons are also suitable). On the other hand, GCN, albeit powerful, takes a long time and a lot more data to train. The training is also non-trivial; it requires a lot of parameter tweaking, learning rate scheduling, and even multiple reruns with randomized initialization in order to succeed. GCN is therefore not amenable to frequent updates of the trained network, and the provided GCDMD method can overcome this problem.

Referring to FIG. 2, the CPU 130 executes machine instructions (or programs) to implementing the provided method for generating trading signals. In step 10, the CPU 130 receives time series data of one or more assets from a data source.

Next, in step 20, the CPU 130 preprocesses the time series data. Specifically, the preprocessing step includes: filling-in missing values; and standardizing a plurality of time series values across the assets of the time series data. As known to one of ordinary skills in the art, missing values can be treated with methods such as data interpolation, extrapolation, and imputation with k-nearest neighbors. As known to one of ordinary skills in the art, data normalization can be done by standardizing each time series to have zero mean and unit standard deviation, rescaling to a fixed maximum and a fixed minimum, rescaling to a fixed initial value, or rescaling to a fixed ending value.

Next, in step 30, the CPU 130 extracts features from the preprocessed time series data to obtain a plurality of time series of feature vectors. Specifically, step 30 includes extracting features from each asset to yield one time series of feature vectors corresponding to each asset, wherein all the time series of the feature vectors form the data matrix corresponding to the time series data. In more details, features may include, but are not limited to, price, simple return, log-return, volatility, and moving average, computed over single or multiple time periods. For the sake of presentation, the features of the different assets may be represented as a data matrix given below.

$$[ \begin{matrix}{x}_{1} ( 1 ) & … & {x}_{1} ( m ) \\ ⋮ & ⋱ & ⋮ \\ {x}_{n} ( 1 ) & … & {x}_{n} ( m )\end{matrix} ]$$

Where, n is the number of assets, m is the number of time instances of one asset among the time series data, and each xᵢ(j) denotes a feature vector (a column with number of entries equals the number of features F) of the i^{th} asset at the j^{th} time instance. In another embodiment, the data matrix can be reorganized into many different forms without altering the results of the subsequent steps.

Furthermore, in step 40, the CPU 130 calculates an affinity matrix representing pairwise similarity between each pair of the assets. Specifically, the affinity matrix is a generic square matrix having entries depicting similarity scores for each pair of assets. The calculated affinity matrix A is an n-by-n matrix depicting the strength of the relationship between the assets. The matrix A is reciting below:

$$A = [ \begin{matrix}{a}_{1 , 1} & … & {a}_{1 , n} \\ ⋮ & ⋱ & ⋮ \\ {a}_{n , 1} & … & {a}_{n , n}\end{matrix} ]$$

Where, a_{i,j} is the affinity (i.e., similarity) between the i^{th} asset and the j^{th} asset. In another embodiment, similarity between two assets can be assessed based on price data or fundamental data of the physical entity underlying the asset. Several commonly used choices for a_{i,j} include: (1) the Pearson correlation coefficient between the time series of asset i and asset j, rescaled to between 0 and 1; (2) 1 if asset i and asset j belong to the same industry sector and 0 otherwise; (3) 1 if asset i and asset j belong to the same supply chain and 0 otherwise; (4) similarity score computed with Dynamic Time Warping (DWT); and (5) number of common top shareholders.

In the context of graph theory, the matrix A is the adjacency matrix, representing the edge weights of a weighted graph. The graph can be directed or undirected. Obviously, a weighted graph supersedes an unweighted graph.

Next, in step 50, the CPU 130 calculates a graph convolved dynamic mode decomposition of data matrix assembled from extracted features. This step represents a “training step” of the pipeline depicted in FIG. 2, which computes the eigenvalues and eigenvectors of the mathematical operator that drives the dynamics of the prices.

In more detail, Referring to FIG. 3, the step of calculating a graph convolved dynamic mode decomposition of data matrix assembled from extracted features (step 50) includes steps 52-58. In step 52, the CPU 130 calculates a graph convolution of the feature vectors, wherein the graph convolution at a node p is a weighted average of the feature vectors at all other nodes, wherein weights for calculating the weighted average are entries, normalized to sum to one, of a row corresponding to the node p in the affinity matrix.

Specifically, the CPU 130 calculates the graph convolution of the feature vectors by formula (1) below:

$${\tilde{x}}_{i} ( j ) = \frac{{\sum }_{k = 1}^{n} {a}_{i , k} {x}_{k} ( j )}{{\sum }_{k = 1}^{n} {a}_{i , k}} \qquad ( 1 )$$

Where i=1, 2, . . . , n and j=1, 2, . . . , m, wherein n is the total number of the assets in the time series data, and m is the total number of the time instances of each time series of asset.

Next, in step 54, the CPU 130 concatenates m feature vectors of each asset with the corresponding convolved m feature vectors to form a concatenated matrix with m columns and 2×F rows, where F is the number of features used. The concatenated matrix is presented by formula (2) below:

$${Z}_{i} = [ \begin{matrix}{x}_{i} ( 1 ) & {x}_{i} ( 2 ) … & {x}_{i} ( m ) \\ {\tilde{x}}_{i} ( 1 ) & {\tilde{x}}_{i} ( 2 ) … & {\tilde{x}}_{i} ( m )\end{matrix} ] \qquad ( 2 )$$

Next, in step 56, the CPU 130 splits the concatenated matrix of each asset into two data matrices corresponding to each asset. Specifically, for each asset i. To make a prediction of τ number of periods ahead (where the length of each period equals to the length of the interval between two consecutive samples in the time series data), step 56 generates two data matrices (matrices Xᵢ and Yᵢ) by splitting the above data matrix Z, into two parts as formulas (3a) and (3b) presented below:

$${X}_{i} = [ \begin{matrix}{x}_{i} ( 1 ) & {x}_{i} ( 2 ) … & {x}_{i} ( m - τ ) \\ {\tilde{x}}_{i} ( 1 ) & {\tilde{x}}_{i} ( 2 ) … & {\tilde{x}}_{i} ( m - τ )\end{matrix} ] \qquad ( 3 a )$$

$${Y}_{i} = [ \begin{matrix}{x}_{i} ( 1 + τ ) & {x}_{i} ( 2 + τ ) … & {x}_{i} ( m ) \\ {\tilde{x}}_{i} ( 1 + τ ) & {\tilde{x}}_{i} ( 2 + τ ) … & {\tilde{x}}_{i} ( m )\end{matrix} ] \qquad ( 3 b )$$

Next, in step 58, the CPU 130 performs, for each asset, the dynamic mode decomposition (DMD) based on the two data matrices corresponding to the concatenated matrix corresponding to each asset to determine an eigenvector matrix Φᵢ and a diagonal matrix of eigenvalues Dᵢ. Specifically, the CPU 130 computes a matrix of eigenvectors Φᵢ and a diagonal matrix of eigenvalues Dᵢ with the following steps:

(1) Computing a singular value decomposition of Xᵢ to obtain Uᵢ, Sᵢ, and Vᵢ: Xᵢ=UᵢSᵢVᵢ^{T}, where Uᵢ is a matrix of left singular vectors, Sᵢ is a diagonal matrix of singular values, and Vᵢ is a matrix of right singular vectors.

(2) Computing the matrix Mᵢ: Mᵢ=Uᵢ^{T}YᵢVᵢSᵢ⁻¹.

(3) Computing an eigenvalue decomposition of Mᵢ to obtain Wᵢ and Dᵢ: Mᵢ=WᵢDᵢWᵢ⁻¹, where Wᵢ is a matrix of eigenvectors of Mᵢ and Dᵢ is a diagonal matrix of eigenvalues of Mᵢ.

(4) Obtain a matrix of eigenvectors Φᵢ: Φᵢ=YᵢVᵢSᵢ⁻Wᵢ.

The computed eigenvectors matrices Φ₁, Φ₂, . . . , Φₙ and the eigenvalues matrices D₁, D₂, . . . , Dₙ for are result outputted by step 50.

Next, in step 60, the CPU 130 determines a prediction of the feature vectors for the assets. Specifically, for each asset i, the predicted values of \tilde{x}ⱼ(m+τ) and xᵢ(m+τ) (which are unknown at the time the prediction is determined) are calculated according to the formula (4) below:

$$[ \begin{matrix}{x}_{i} ( m + τ ) \\ {\tilde{x}}_{i} ( m + τ )\end{matrix} ] = {Φ}_{i} {D}_{i} {Φ}_{i}^{†} [ \begin{matrix}{x}_{i} ( m ) \\ {\tilde{x}}_{i} ( m )\end{matrix} ] \qquad ( 4 )$$

Where Φᵢ^{†} indicates the Moore-Penrose pseudo inverse of Φᵢ, and the predicted feature vector x₁(m+τ), x₂(m+τ), . . . , xₙ(m+τ) are fed into step 70.

Next, in step 70, the CPU 130 extracts trading signals from the predicted feature vectors to the financial instruments. Specifically, step 70 includes: comparing one predicted feature vector of one asset with last feature vector in the time series of the asset, wherein if a predicted price corresponding to the said one predicted feature vector is higher than a price corresponding to the last feature vector by a predefined threshold, generating a first type of trading signals for the said one asset to the financial instruments; if the predicted price corresponding to the said one predicted feature vector is lower than the price corresponding to the last feature vector by a further predefined threshold, generating a second type of trading signals for the said one asset to the financial instruments; else generating a third type of trading signals for the said one asset to the financial instruments.

The CPU 130 determines a trading signal (buy, sell, or no action) for asset i by comparing the predicted feature vector xᵢ(m+τ) with the present feature vector xᵢ(m). Depending on the features chosen, one of ordinary skills in the art should be easy to devise rules to make the trading action. For example, in some embodiments, if one of the features is the present price, then a buy (or sell) signal can be issued if the predicted price is higher (or lower) than the present price by a predefined threshold.

As another example, in some embodiments, if one of the features is the present return (i.e., percentage change of price over some period of time), then a buy (or sell) signal can be issued if the predicted return is higher (or lower) than a predefined non-negative (or non-positive) threshold. One of ordinary skills in the art should be easy to devise minor variants of the two aforementioned example rules. For example, a buy signal is issued only if the predicted return is positive for two consecutive predictions.

The above exemplary embodiment and operations serve only as illustration of the present invention, and an ordinarily skilled person in the art will appreciate that other structural and functional configurations and applications are possible and readily adoptable without undue experimentation and deviation from the spirit of the present invention.

The functional units of the apparatuses and the methods in accordance to embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method of generating trading signals for one or more financial instruments by an electronic device, comprising:
receiving, by a processor of the electronic device, time series data of one or more assets from a data source;
preprocessing, by the processor, the time series data;
extracting, by the processor, features from the preprocessed time series data to obtain a plurality of time series of feature vectors;
calculating, by the processor, an affinity matrix representing pairwise similarity between each pair of the assets;
calculating, by the processor, a graph convolved dynamic mode decomposition of data matrix assembled from extracted features;
determining, by the processor, a prediction of the feature vectors for the assets; and
extracting, by the processor, trading signals from the predicted feature vectors to the financial instruments.

2. The computer-implemented method of claim 1, the step of preprocessing the time series data comprises:
filling-in missing values; and
standardizing a plurality of time series values across the assets of the time series data.

3. The computer-implemented method of claim 1, the step of extracting features from the preprocessed time series data to obtain a plurality of time series of feature vectors comprises:
extracting features from each asset to yield one time series of feature vectors corresponding to each asset, wherein all the time series of the feature vectors form the data matrix corresponding to the time series data.

4. The computer-implemented method of claim 1, wherein the affinity matrix is a generic square matrix having entries depicting similarity scores for each pair of assets, wherein diagonal entries are a constant,
wherein one similarity score of one pair of assets is determined based on price data or fundamental data of physical entity underlying the said one pair of assets.

5. The computer-implemented method of claim 1, wherein the step of calculating the graph convolved dynamic mode decomposition of data matrix assembled from extracted features comprises:
calculating a graph convolution of the feature vectors, wherein the graph convolution at a node p is a weighted average of the feature vectors at all other nodes, wherein weights for calculating the weighted average are entries, normalized to sum to one, of a row corresponding to the node p in the affinity matrix;
concatenating m feature vectors of each asset with the corresponding convolved m feature vectors to form a concatenated matrix with m columns and 2×F rows, where F is the number of features used;
splitting the concatenated matrix of each asset into two data matrices corresponding to each asset; and
performing, for each asset, the dynamic mode decomposition (DMD) based on the two data matrices corresponding to the concatenated matrix corresponding to each asset to determine an eigenvector matrix Φᵢ and a diagonal matrix of eigenvalues Dᵢ.

6. The computer-implemented method of claim 1, wherein the step of determining the prediction of the feature vectors for the assets comprises:
multiplying, for each asset i, the matrix ΦᵢDᵢΦᵢ^{†} with the last column of the concatenated matrix, so as to obtain the predicted feature vectors.

7. The computer-implemented method of claim 1, wherein the step of extracting the trading signals from the predicted feature vectors comprises:
comparing one predicted feature vector of one asset with last feature vector in the time series of the asset,
wherein if a predicted price corresponding to the said one predicted feature vector is higher than a price corresponding to the last feature vector by a predefined threshold, generating a first type of trading signals for the said one asset to the financial instruments;
if the predicted price corresponding to the said one predicted feature vector is lower than the price corresponding to the last feature vector by a further predefined threshold, generating a second type of trading signals for the said one asset to the financial instruments; else
generating a third type of trading signals for the said one asset to the financial instruments.

8. An electronic device for generating trading signals for one or more financial instruments, comprising:
a non-volatile computer-readable medium, configured to store machine instructions; and
a processor, configured to execute the machine instructions to implement a method comprising:
receiving, by the processor, time series data of one or more assets from a data source;
preprocessing, by the processor, the time series data;
extracting, by the processor, features from the preprocessed time series data to obtain a plurality of time series of feature vectors;
calculating, by the processor, an affinity matrix representing pairwise similarity between each pair of the assets;
calculating, by the processor, a graph convolved dynamic mode decomposition of data matrix assembled from extracted features;
determining, by the processor, a prediction of the feature vectors for the assets; and
extracting, by the processor, trading signals from the predicted feature vectors to the financial instruments.

9. The electronic device of claim 8, the step of preprocessing the time series data comprises:
filling-in missing values; and
standardizing a plurality of time series values across the assets of the time series data.

10. The electronic device of claim 8, the step of extracting features from the preprocessed time series data to obtain a plurality of time series of feature vectors comprises:
extracting features from each asset to yield one time series of feature vectors corresponding to each asset, wherein all the time series of the feature vectors form the data matrix corresponding to the time series data.

11. The electronic device of claim 8, wherein the affinity matrix is a generic square matrix having entries depicting similarity scores for each pair of assets, wherein diagonal entries are a constant,
wherein one similarity score of one pair of assets is determined based on price data or fundamental data of physical entity underlying the said one pair of assets.

12. The electronic device of claim 8, wherein the step of calculating the graph convolved dynamic mode decomposition of data matrix assembled from extracted features comprises:
calculating a graph convolution of the feature vectors, wherein the graph convolution at a node p is a weighted average of the feature vectors at all other nodes, wherein weights for calculating the weighted average are entries, normalized to sum to one, of a row corresponding to the node p in the affinity matrix;
concatenating m feature vectors of each asset with the corresponding convolved m feature vectors to form a concatenated matrix with m columns and 2×F rows, where F is the number of features used;
splitting the concatenated matrix of each asset into two data matrices corresponding to each asset; and
performing, for each asset, the dynamic mode decomposition (DMD) based on the two data matrices corresponding to the concatenated matrix corresponding to each asset to determine an eigenvector matrix Φᵢ and a diagonal matrix of eigenvalues Dᵢ.

13. The electronic device of claim 8, wherein the step of determining the prediction of the feature vectors for the assets comprises:
multiplying, for each asset i, the matrix ΦᵢDᵢΦᵢ^{†} with the last column of the concatenated matrix, so as to obtain the predicted feature vectors.

14. The electronic device of claim 8, wherein the step of extracting the trading signals from the predicted feature vectors comprises:
comparing one predicted feature vector of one asset with last feature vector in the time series of the asset,
wherein if a predicted price corresponding to the said one predicted feature vector is higher than a price corresponding to the last feature vector by a predefined threshold, generating a first type of trading signals for the said one asset to the financial instruments;
if the predicted price corresponding to the said one predicted feature vector is lower than the price corresponding to the last feature vector by a further predefined threshold, generating a second type of trading signals for the said one asset to the financial instruments; else
generating a third type of trading signals for the said one asset to the financial instruments.

15. A system for generating trading signals for one or more financial instruments, comprising:
a data source, configured to provide time series data of one or more assets; and
an electronic device, comprising:
a non-volatile computer-readable medium, configured to store machine instructions; and
a processor, configured to execute the machine instructions to implement a method comprising:
receiving, by the processor, the time series data from the data via a network connection to the data source;
preprocessing, by the processor, the time series data;
extracting, by the processor, features from the preprocessed time series data to obtain a plurality of time series of feature vectors;
calculating, by the processor, an affinity matrix representing pairwise similarity between each pair of the assets;
calculating, by the processor, a graph convolved dynamic mode decomposition of data matrix assembled from extracted features;
determining, by the processor, a prediction of the feature vectors for the assets; and
extracting, by the processor, trading signals from the predicted feature vectors to the financial instruments.
